(19) United States
(12) Patent Application Publication
(10) Pub. No.: US 2015/0057376 A1
(43) Pub. Date: Feb. 26, 2015

(54) Method and Device for Generating Hydrogen Plasma

(71) Applicant: Taneaki Oikawa, Miyagi (JP)

(72) Inventor: Taneaki Oikawa, Miyagi (JP)

(73) Assignee: TAANE CO., Miyagi (JP)

(21) Appl. No.: 14/390,366

(22) PCT Filed: Apr. 2, 2012
(86) PCT No.: PCT/JP2012/058863

§ 371 Date: Oct. 2, 2014

(51) Int. Cl. B01F 3/08; B01J 19/12; B01F 5/04; B01J 19/10

(52) U.S. Cl. CPC B01F 3/0811; B01J 19/10; B01J 19/126; B01J 19/127; B01F 5/04; B01F 2215/0067; B01F 2003/0842
USPC 516/20; 204/157.42; 204/157.43; 422/128; 422/186.29

(57) ABSTRACT

A method for generating hydrogen plasma includes a step for preparing a solution in which hydrogenated hydrogen with ion binding properties or ortho hydrogen molecules have been dissolved. The method also includes exposing the solution to ultrasonic waves or microwaves. Preferably, microbubbles are agitated by projecting ultrasonic waves or microwaves as solar energy, generating hydrogen plasma when the microbubbles burst.

This patent application is a national phase filing under section 371 of PCT/JP2012/058863, filed Apr. 2, 2012, which is incorporated herein by reference in its entirety.

### TECHNICAL FIELD

The present invention relates to a method and apparatus for generating hydrogen plasma in liquid.

### BACKGROUND

Generation of vapor phase plasma has been applied to film formation of semiconductor layers, however, generation of plasma in liquid has not yet been fully researched. Although it has been considered that arc discharge is performed in liquid to generate plasma, it is pointed out that its energy efficiency is low since most of power is consumed for the flow of electrons. In addition, in a case where plasma is generated by radiating electromagnetic waves into liquid, it has been pointed out that an eddy current is generated in conductive liquid such as water or alcohol, and the energy of the electromagnetic waves may be dissipated, or the electromagnetic waves may be attenuated because a hydroxyl group or the like absorbs a specified frequency (see, Japanese patent No. 4,446,030).

An apparatus for generating plasma in liquid in Japanese patent No. 4,446,030, therefore, comprises a container for retaining liquid, an electromagnetic wave radiation source for radiating electromagnetic waves into liquid, a bubble generation device for generating bubbles in liquid, and a bubble retention device for retaining the bubbles near the electromagnetic wave radiation source, wherein the bubble retention device is a pair of an ultrasonic radiation source and an ultrasonic reflection plate that are disposed above and below the bubbles, and electromagnetic waves are radiated to the bubbles to generate plasma in the bubbles. In addition, Japanese patent No. 4,560,606, describes an apparatus for generating plasma by radiating electromagnetic waves to the bubbles in liquid, and the apparatus comprises a micro bubble generator for providing vapor reducing agent in the liquid.

### SUMMARY OF THE INVENTION

Embodiments of the present invention provide a method and apparatus for generating hydrogen plasma in liquid at ordinary temperatures and atmospheric pressure.

Other embodiments of the present invention provide a method and apparatus for emulsifying oil by hydrogen plasma.

A method for generating hydrogen plasma according to the present invention comprises a step of preparing a solution that contains ortho-hydrogen molecules being dissolved therein, and a step of radiating ultrasonic waves or microwaves to the solution.

A method for generating hydrogen plasma according to the present invention comprises a step of preparing a solution that contains ionically bonded hydrogen being dissolved therein, and radiating ultrasonic waves or microwaves to the solution.

Preferably, in the solution, ionization of hydrogen molecules as in H₂⁰ [symbol] H⁺+H⁻ causes micro bubbles to be formed, and the radiation of the ultrasonic waves or microwaves causes the micro bubbles to burst, and thus hydrogen plasma is generated. Preferably, in one embodiment method for generating hydrogen plasma, the ultrasonic waves or microwaves for the irradiation are ultrasonic waves or microwaves as solar energy.

A method for emulsifying oil of the present invention emulsifies oil by the hydrogen plasma that is generated by the method for generating hydrogen plasma described above. Preferably, the method for emulsification comprises a step of injecting oil into the solution.

An apparatus for generating hydrogen plasma according to the present invention comprises a retention container for retaining a solution that contains ortho-hydrogen molecules being dissolved therein, and a radiation source for radiating ultrasonic waves or microwaves to the retained solution.

An apparatus for generating hydrogen plasma according to the present invention comprises a retention container for retaining a solution that contains ionically bonded hydrogen being dissolved therein, and a radiation source for radiating ultrasonic waves or microwaves to the retained solution.

Preferably, in one embodiment apparatus for generating hydrogen plasma, in the solution, ionization of hydrogen molecules as in H₂⁰ [symbol] H⁺+H⁻ causes micro bubbles to be formed, and the irradiation of the ultrasonic waves or microwaves causes the micro bubbles to burst, and thus hydrogen plasma is generated. Preferably, the radiation source radiates ultrasonic waves or microwaves as solar energy.

An apparatus for emulsification according to the present invention comprises the apparatus for generating hydrogen plasma described above, and an injection device for injecting oil into the solution retained in the retention container.

According to the present invention, hydrogen plasma can be generated in liquid at ordinary temperatures and atmospheric pressure by radiating ultrasonic waves or microwaves toward a solution that contains ortho-hydrogen molecules or ionically bonded hydrogen being dissolved. In addition, droplets of emulsion oil can be made finer by using generation of such hydrogen plasma.

### BRIEF DESCRIPTION OF THE DRAWINGS

FIG. 1 is a table illustrating a classification of hydrogen molecules;

FIG. 2, which includes FIGS. 2A and 2 B, illustrates in (2A) a structure of an ortho-hydrogen molecule, and in (2B) a structure of a para-hydrogen molecule;

FIG. 3 is a schematic view of a water-soluble hydrogen molecule and a water-insoluble hydrogen molecule;

FIG. 4A is a graph illustrating the relation over time between oxidation reduction potential (ORP) and pH, where hydrogen gas of para-hydrogen molecules is added to water;

FIG. 4B is a graph illustrating the relation over time between dissolved hydrogen and pH in the water of FIG. 4A;

FIG. 5A is a graph illustrating the relation over time between oxidation reduction potential (ORP) and pH, where hydrogen gas of ortho-hydrogen molecules is added to water;

FIG. 5B illustrates the relation over time between dissolved hydrogen and pH in the water of FIG. 5A;

FIG. 6A is a graph illustrating the relation over time between dissolved hydrogen and pH, where oxygen gas is added to the water of FIG. 5A;

FIG. 6B is a graph illustrating the relation over time between dissolved hydrogen and pH, where an oxide is added to the water of FIG. 5A;

FIG. 7 is a flowchart illustrating steps in a method for generating hydrogen plasma according to an embodiment of the present invention;

FIG. 8 is a photo showing a state of emulsion oil that is emulsified by ionized hydrogen water;

FIG. 9 is a photo showing a state of emulsion oil of FIG. 8 which has been irradiated with solar energy; and

FIG. 10, which includes FIGS. 10A and 10B, illustrates in (10A) a configuration example of an apparatus for generating hydrogen plasma according to an embodiment of the present invention, and in (10B) a configuration example of an apparatus for emulsification according to an embodiment of the present invention.

### DETAILED DESCRIPTION OF ILLUSTRATIVE EMBODIMENT

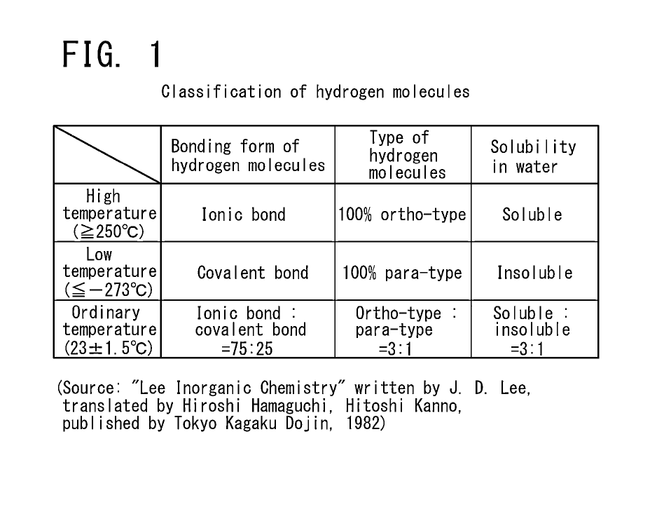

In FIG. 1, hydrogen molecules are classified with reference to temperature. As shown in FIG. 1, the bonding form of hydrogen molecules is ionic bond at high temperatures (equal to or greater than 250 degrees Celsius), and covalent bond at low temperatures (equal to or less than −273 degrees Celsius). At ordinary temperature (23±1.5 degrees Celsius), the ratio of ionic bond to covalent bond is 75%:25%.

The type of hydrogen molecules is 100% ortho-type in a case where their hydrogen bond is ionic bond. On the other hand, the type of hydrogen molecules is 100% para-type in a case where their hydrogen bond is covalently bond. At ordinary temperature, the ratio of ortho-type to para-type is 3:1.

Ionically bonded hydrogen is water-soluble. On the other hand, covalently bonded hydrogen is water-insoluble. At ordinary temperature, the ratio of soluble to insoluble is 3:1. These relations between hydrogen molecules and temperatures are derived by referring to “Lee Inorganic Chemistry” written by J. D. Lee, translated into Japanese by Hiroshi Hamaguchi, Hitoshi Kanno, published by Tokyo Kagaku Dojin, 1982).

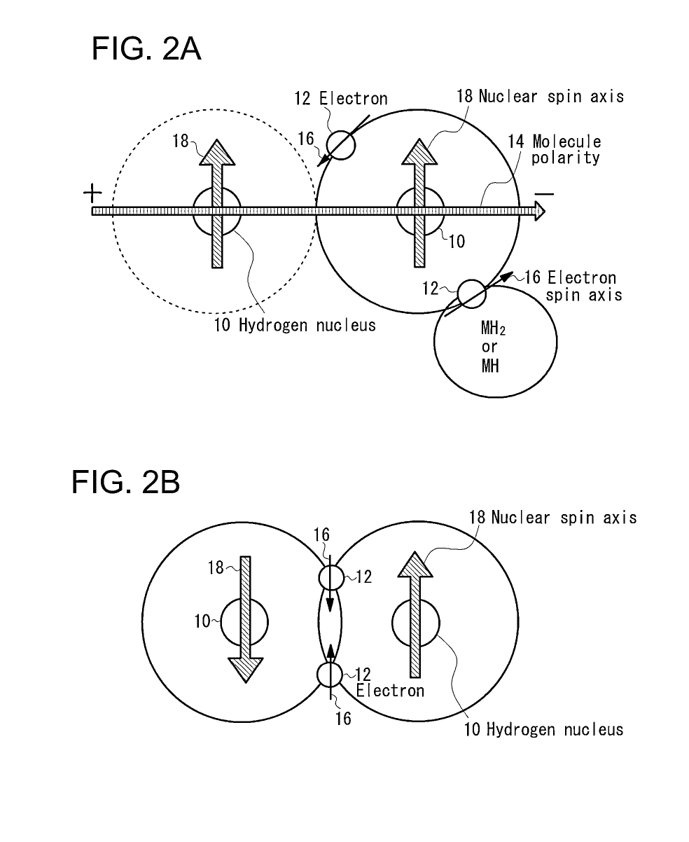

FIG. 2 (A) illustrates a structure of a water-soluble, ortho-hydrogen molecule. FIG. 2 (B) illustrates a structure of a water-insoluble, para-hydrogen molecule. In the ortho-hydrogen molecule form, as shown in FIG. 2 (A), nuclear spin axes 18 of two hydrogen nuclei 10 are in the same orientation, and two electrons 12 freely move around one hydrogen nucleus 10. As a result, a molecule polarity 14 as shown in FIG. 2 (A) occurs. On the other hand, in the para-hydrogen molecule form, the orientations of the nuclear spin axes 18 are opposite and two electrons 12 are shared by two hydrogen nuclei 10, as shown in FIG. 2 (B). As a result, no molecule polarity occurs.

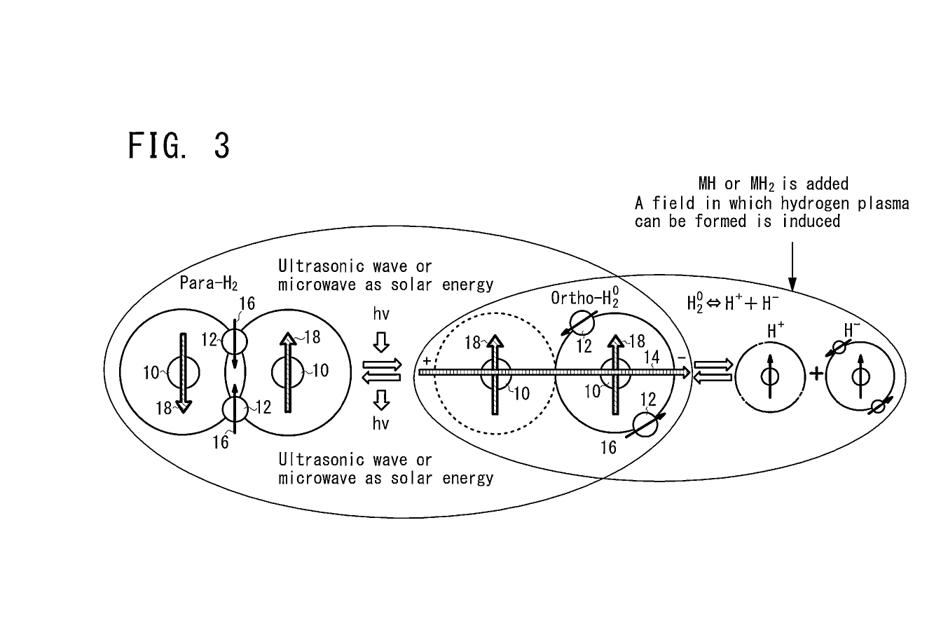

FIG. 3 is a schematic view of water-insoluble para-H₂ and water-soluble ortho-H₂. As described above, at a low temperature of −273 degrees Celsius, 100% of hydrogen molecules are water-insoluble para-type, in other words, in a state of covalently bonded hydrogen. The covalently bonded hydrogen is not ionized even when it is put into water, i.e., H₂═H.H.

On the other hand, in an oxygen-free reduction state at high temperatures equal to or greater than 250 degrees Celsius, 100% of hydrogen molecule are water-soluble ortho-type, in other words, in a state of ionically bonded hydrogen. When solar energy hv is irradiated to para-hydrogen molecules, hydrogen molecules are converted from para-type into ortho-type. When the radiation of the solar energy hv is stopped, hydrogen molecules are converted from ortho-type into para-type. This is experimented in: Michael Frunzi et al., “A Photochemical On-Off Switch for Tuning the Equilibrium Mixture of H₂ Nuclear Spin Isomers as a Function of Temperature”, Journal of the American Chemical Society (JACS), No. 133, pp. 14232-14235, 2011. In addition, as shown in FIG. 2 (A) and FIG. 3, an addition of MH or MH₂ (M stands for a metal, and MH or MH₂ stands for a metal hydride) induces a field in which hydrogen plasma can be formed, as described later.

Results of an experiment on para- and ortho-hydrogen molecules is now described. For the experiment, MM-60R available from DKK-TOA was used for an ORP/pH meter, and DH-35A available from DKK-TOA was used for a dissolved hydrogen meter.

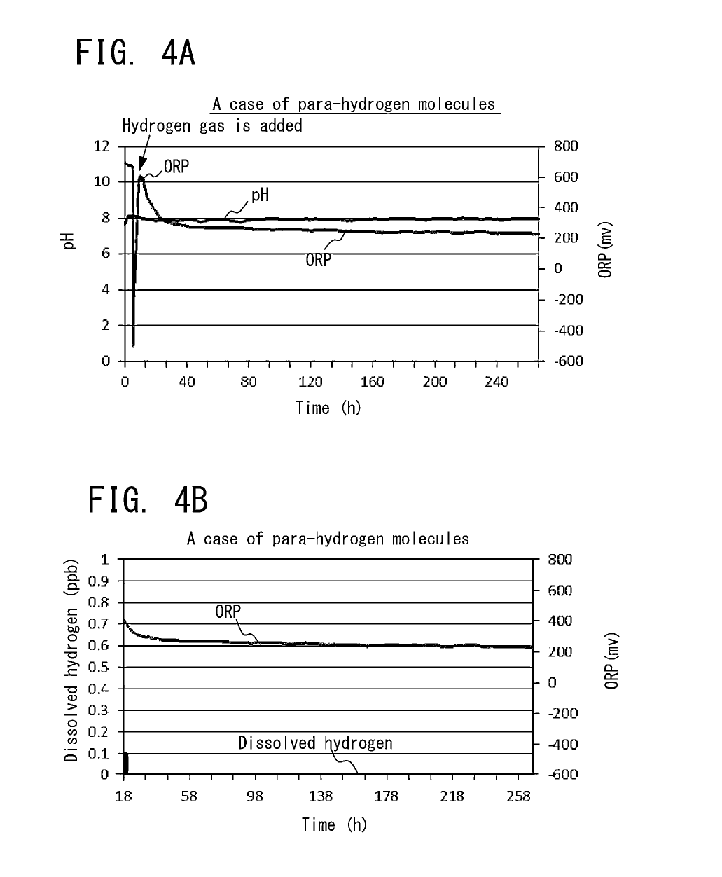

For the experiment, water to which hydrogen gas of para-hydrogen molecules was added was used. FIG. 4A illustrates the relation over time between oxidation reduction potential (ORP) and pH, where hydrogen gas of para-hydrogen molecules is added to water. FIG. 4B illustrates the relation over time between dissolved hydrogen and pH in the solution of FIG. 4A. ORP temporally decreases when hydrogen gas is added, however, ORP soon returns to its original potential. In addition, there is almost no change in pH. Hydrogen gas is temporally generated when hydrogen gas is added, however, after that, hydrogen gas is not generated so much. It can be found that hydrogen is not ionized when covalently bonded hydrogen molecules are put into water, and hydrogen is not dissolved in the water.

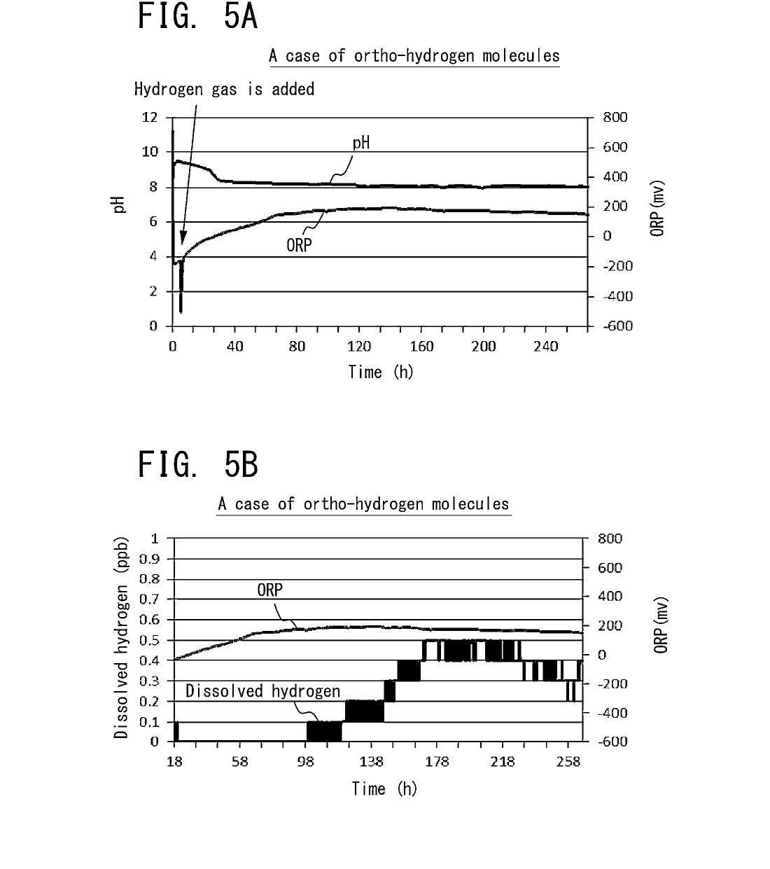

FIG. 5A illustrates the relation over time between oxidation reduction potential (ORP) and pH, where hydrogen gas of ortho-hydrogen molecules is added to water. FIG. 5B illustrates the relation over time between dissolved hydrogen and pH in the water of FIG. 5A. ORP decreases when hydrogen gas is added, and after that, ORP gradually increases. In addition, pH is about pH 9 when hydrogen gas is added, and after that, the value gradually converges on about pH 8. In addition, as shown in FIG. 5B, hydrogen is gradually generated after 84 hours have elapsed, and hydrogen is continuously generated even after 250 hours. In other words, it can be found that, hydrogen is ionized when the ortho-hydrogen molecules are put into water, and hydrogen is dissolved in the water.

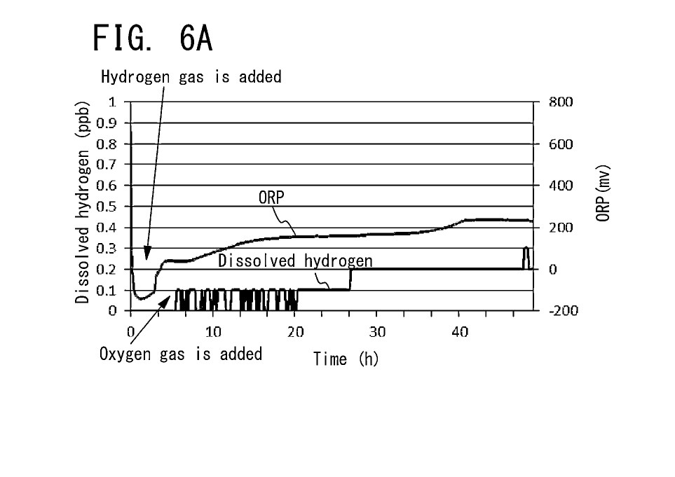

FIG. 6A illustrates the relation over time between ORP and dissolved hydrogen, where ortho-hydrogen molecules are added to water as in FIG. 5A and then oxygen gas is added thereto. It can be found that, after oxygen gas is added, hydrogen dissolved in the water is forced to be generated. After that, the generation of hydrogen continues over 40 hours.

FIG. 6B illustrates that, when ortho-hydrogen molecules are added to water as in FIG. 5A, and then an oxide (a substance comprising an acid) is added, hydrogen dissolved in the water is abruptly generated in a large amount, and the amount reaches 80 ppb at its peak. After that, the generation of hydrogen continues over 90 hours.

As such, when ionically bonded hydrogen molecules (ortho-type) are put into water, hydrogen is ionized, and becomes stable as in H₂ [symbol] H⁺+H⁻, and thus ionized hydrogen water (plasma water) is formed. On the other hand, hydrogen is not ionized when covalently bonded hydrogen molecules (para-type) are put into water, i.e., H₂═H.H, resulting in non-ionized hydrogen water. Ionized hydrogen water can be stored at ordinary temperatures and atmospheric pressure. In addition, it has been confirmed that the antioxidative ability of the water is kept over one and half years.

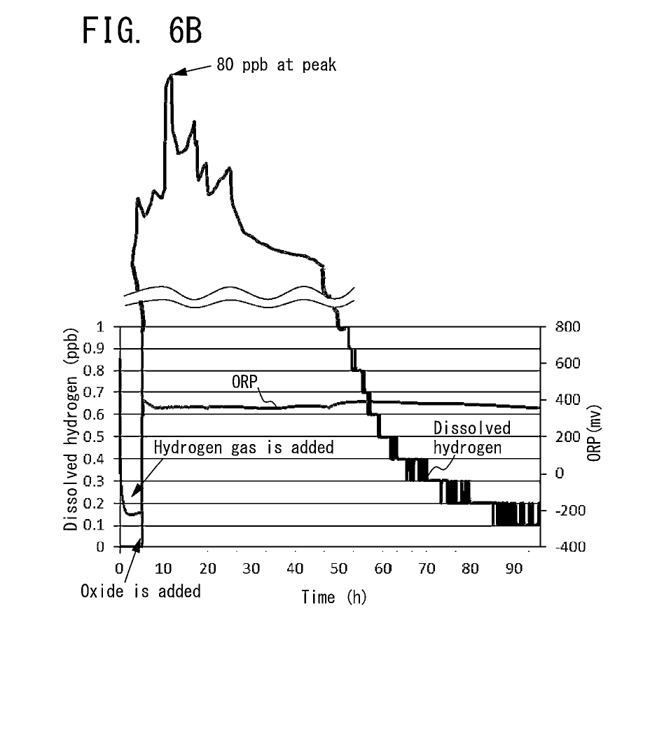

A method for generating hydrogen plasma according to an embodiment of the present invention is now described wth respect to the flow chart of FIG. 7. First, ionized hydrogen water is prepared as a solution (for example, water) in which ortho-hydrogen molecules are dissolved (S101). Ionized hydrogen water comprises ortho-hydrogen molecules or ionically bonded hydrogen molecule, and hydrogen molecules are ionized as in H₂⁰ [symbol] H⁺+H⁻ in liquid. Such ionized hydrogen water may be obtained, for example, by adding a metal hydride such as CaH₂, MgH₂, etc. to water. For the metal hydride to be added, other than those described above, an alkali metal, an alkali earth metal, a Group 13 or Group 14 metal shown on a periodic table of elements may be used.

Then, ultrasonic waves or microwaves as solar energy are radiated into the ionized hydrogen water (S102). Other than the irradiating solar rays, artificially generated ultrasonic waves or microwaves of a selected wavelength may be radiated into the ionized hydrogen water. In ionized hydrogen water, hydrogen molecules are ionized as in H₂⁰ [symbol] H⁺+H⁻, thereby micro bubbles are formed. When ultrasonic waves or microwaves are radiated into the ionized hydrogen water, micro bubbles are agitated (S103), and micro cavitation occurs (S104), and finer micro bubbles are formed (S105), and a field in which hydrogen plasma can be formed (a field in which hydrogen plasma can be decomposed and synthesized) is induced (S106). The finer micro bubbles reunite together and grow into larger micro bubbles, and when they grow up to a certain size they cannot withstand, the micro bubbles burst and hydrogen plasma is generated (S107). The development and burst of micro bubbles occur sequentially in water. As such, when a field in which hydrogen plasma can be formed is induced in liquid of ionized hydrogen water and then atomized micro bubbles burst, hydrogen plasma is generated.

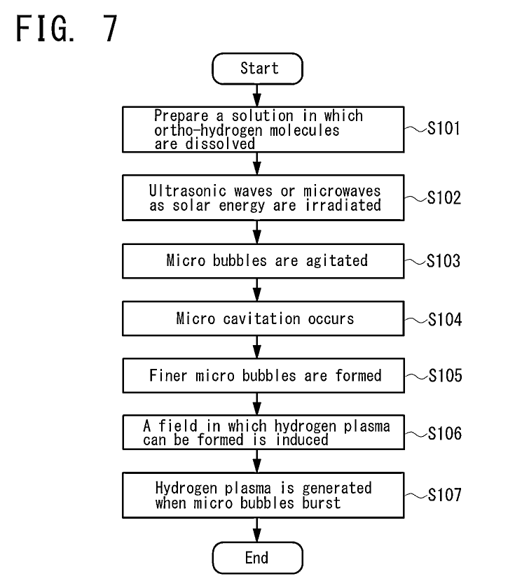

An example is now described in which a method for generating hydrogen plasma of the present invention is applied to a method for manufacturing emulsion oil. By generating hydrogen plasma in liquid, emulsion oil with high quality can be stably refined. The photo shown in FIG. 8 illustrates emulsion oil having various droplet sizes. The emulsion oil is generated in ionized hydrogen water by soaking into ulrapure water 0.25% CaH₂ and MgH₂ that are generated by reduction-firing CaO and MgO, which are mixed at a weight ratio ratio of 1:1, in an oxygen-free reduction atmosphere. The diameter of some droplets may be 20 micrometers, and the diameter of some other droplets may be 50 micrometers. It should be noted that the oil emulsion described herein is emulsified by ionized hydrogen water without adding a surfactant or an emulsifier or the like.

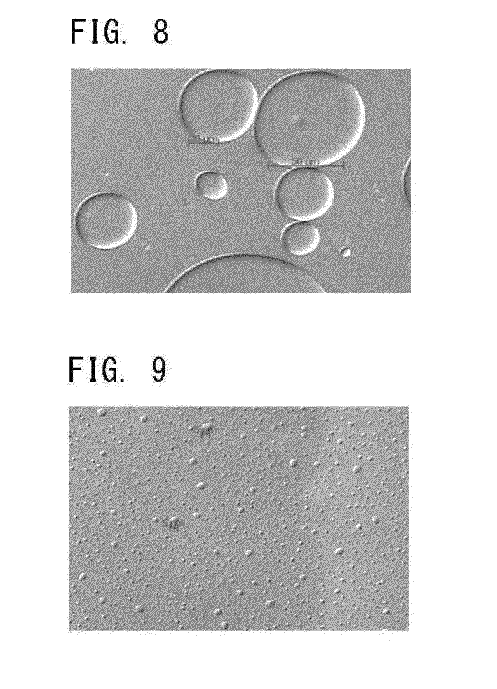

The emulsion oil shown in FIG. 8 is irradiated with ultrasonic waves or microwaves as solar energy. As described above, ionized hydrogen water induces a field in which hydrogen plasma can be formed, and hydrogen plasma is generated when micro bubbles agitated by solar energy burst. FIG. 9 shows emulsion oil after solar rays are radiated into the emulsion oil of FIG. 8. As obvious also from this photo, it can be found that droplets become finer by the generation of hydrogen plasma. In the example in FIG. 9, the diameter of one droplet is about 5 micrometers.

The droplet size of emulsion oil becomes finer by irradiating solar rays thereto. However, when the radiation of solar energy is stopped, the droplet size of the emulsion oil returns to its original size, in other words, becomes relatively large, as large droplet size as shown in FIG. 8. Therefore, the droplet size of emulsion oil can be altered by controlling the radiation of solar rays, or the radiation of artificially generated micro waves or ultrasonic waves, to the emulsion oil.

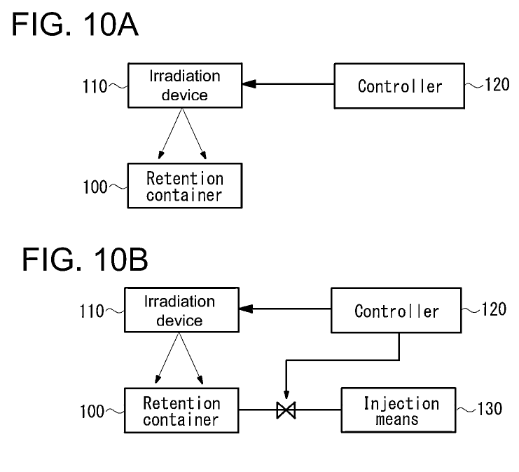

FIG. 10 (A) is a block diagram illustrating a configuration example of an apparatus for generating hydrogen plasma according to an embodiment of the present invention. The apparatus for generating hydrogen plasma of this embodiment is configured to comprise a retention container 100 for retaining ionized hydrogen water in which at least ortho-hydrogen molecules are dissolved, an radiation source 110 for irradiating ultrasonic waves or microwaves to the ionized hydrogen water in the retention container 100, and a controller 120 for controlling the irradiation of the radiation source 110. In a case where the radiation source 110 performs irradiation of solar energy, the radiation source 110 may be configured to comprise a shutter that passes through or shields solar rays. The controller 120 may control open and close of a shutter, or the time of the shutter to be opened or closed.

FIG. 10 (B) is a block diagram illustrating a configuration example of an apparatus for emulsification according to an embodiment of the present invention. The apparatus for emulsification of this embodiment comprises, in addition to the configuration of FIG. 10 (A), an injection device 130 for injecting oil. In a case where oil solidifies at ordinary temperature, the oil is heated to be liquefied, and the oil is mixed with the ionized hydrogen water in the retention container 100. The controller 120 controls via a valve, for example, the timing and amount of the oil to be injected.

Although preferred embodiments of the present invention have been described in detail, the present invention is not to be limited to specific embodiments, and various modifications and alternations can be made without departing from the scope and the spirit of the invention.

1-11. (canceled)

12. A method for generating hydrogen plasma, the method comprising:
preparing a solution that contains ortho-hydrogen molecules that are dissolved in the solution; and
irradiating the solution with ultrasonic waves or microwaves.

13. The method according to claim 12, wherein, in the solution, ionization of hydrogen molecules as in H₂⁰ [symbol] H++H− causes micro bubbles to be formed, and the irradiation with the ultrasonic waves or microwaves causes the micro bubbles to burst, wherein hydrogen plasma is generated.

14. The method according to claim 12, wherein the ultrasonic waves or microwaves for the irradiation comprise ultrasonic waves or microwaves as solar energy.

15. A method for emulsification, the method comprising emulsifying oil by hydrogen plasma that is generated by the method for generating hydrogen plasma according to claim 12.

16. The method according to claim 15, further comprising injecting oil into the solution.

17. A method for generating hydrogen plasma, the method comprising:
preparing a solution that contains ionically bonded hydrogen that is dissolved in the solution; and
irradiating the solution with ultrasonic waves or microwaves.

18. The method according to claim 17, wherein, in the solution, ionization of hydrogen molecules as in H₂⁰ [symbol] H++H− causes micro bubbles to be formed, and the irradiation with the ultrasonic waves or microwaves causes the micro bubbles to burst, wherein hydrogen plasma is generated.

19. The method according to claim 17, wherein the ultrasonic waves or microwaves for the irradiation comprise ultrasonic waves or microwaves as solar energy.

20. A method for emulsification, the method comprising emulsifying oil by hydrogen plasma that is generated by the method for generating hydrogen plasma according to claim 17.

21. The method according to claim 20, further comprising injecting oil into the solution.

22. An apparatus for use in generating hydrogen plasma, the apparatus comprising:
a container configured to retain a solution that contains ortho-hydrogen molecules that are dissolved in the solution; and
a radiation source located adjacent the container to irradiate the solution with ultrasonic waves or microwaves.

23. The apparatus according to claim 22, wherein, in the solution, ionization of hydrogen molecules as in H₂⁰ [symbol] H++H− causes micro bubbles to be formed, and the radiation of the ultrasonic waves or microwaves causes the micro bubbles to burst, wherein hydrogen plasma is generated.

24. The apparatus according to claim 22, wherein the radiation source radiates ultrasonic waves or microwaves as solar energy.

25. An apparatus for emulsification, the apparatus comprising:
the apparatus according to claim 22; and
an injection device located adjacent the container to inject oil into the solution retained in the container.

26. An apparatus for use in generating hydrogen plasma, the apparatus comprising:
a container configured to retain a solution that contains ionically bonded hydrogen that is dissolved in the solution; and
a radiation source located adjacent the container to irradiate the solution with ultrasonic waves or microwaves.

27. The apparatus according to claim 26, wherein, in the solution, ionization of hydrogen molecules as in H₂⁰ [symbol] H++H− causes micro bubbles to be formed, and the radiation of the ultrasonic waves or microwaves causes the micro bubbles to burst, wherein hydrogen plasma is generated.

28. The apparatus according to claim 26, wherein the radiation source radiates ultrasonic waves or microwaves as solar energy.

29. An apparatus for emulsification, the apparatus comprising:
the apparatus according to claim 26; and
an injection device located adjacent the container to inject oil into the solution retained in the container.
